(19) United States
(12) Patent Application Publication
(10) Pub. No.: US 2018/0126401 A1
(43) Pub. Date: May 10, 2018

(54) Safety Button System and Method of Use

(71) Applicant: MMLJ, Inc, Houston, TX (US)

(72) Inventor: Benjamin LeCompte, Houston, TX (US)

(21) Appl. No.: 15/809,927

(22) Filed: Nov. 10, 2017

Related U.S. Application Data
(60) Provisional application No. 62/420,356, filed on Nov. 10, 2016.

(51) Int. Cl. B05B 12/00; G05G 1/02

(52) U.S. Cl. CPC B05B 12/002; G05G 5/05; G05G 1/02

(57) ABSTRACT

A spray system. Said spray system comprises a button assembly, a controller, a spray hose and a spray head. Said button assembly comprises an external shell and an internal components. Said internal components comprises a FOB and a button portion. Said external shell is configured to protecting said internal components from liquids. Said external shell comprises a debris membrane, a debris membrane hold-down plate, a bottom housing and a top housing. Said internal components comprises a one or more springs. Said top housing comprises a one or more side guards, a button cavity and a one or more lower spring seats. Said FOB comprises a wireless transponder in communication with said controller. Said button portion comprises a lower extension and a one or more upper spring seats.

### CROSS-REFERENCE TO RELATED APPLICATIONS

This application claims benefit to U.S. patent application Ser. No. 62/420,356 filed on Nov. 10, 2016.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant.

None of the known inventions and patents, taken either singularly or in combination, is seen to describe the instant disclosure as claimed.

### BRIEF SUMMARY OF THE INVENTION

A spray system. Said spray system comprises a button assembly, a controller, a spray hose and a spray head. Said button assembly comprises an external shell and an internal components. Said internal components comprises a FOB and a button portion. Said external shell is configured to protecting said internal components from liquids. Said external shell comprises a debris membrane, a debris membrane hold-down plate, a bottom housing and a top housing. Said internal components comprises a one or more springs. Said top housing comprises a one or more side guards, a button cavity and a one or more lower spring seats. Said FOB comprises a wireless transponder in communication with said controller. Said button portion comprises a lower extension and a one or more upper spring seats. Said one or more springs are situated between said one or more upper spring seats and said one or more lower spring seats and are configured to press said button portion and said top housing apart. Said button cavity comprises a one or more internal clips.

A spray system. Said spray system comprises a button assembly, a controller, a spray hose, a spray head, a top side, a bottom side, a front side, a back side, a first side and a second side. Said button assembly comprises an external shell, an internal components and a button. Said internal components comprises a FOB and a button portion. Said external shell is configured to protecting said internal components from liquids. Said FOB comprises a wireless transponder in communication with said controller.

A method of using a safety button. Said method of using a safety button comprises a connecting a button assembly and controller step, a selectively engaging said controller and a spray system with said button assembly step and a disengaging said spray system when a signal between said button assembly and said controller is lost step. Comprises: creating a wireless signal between a button assembly and a controller of. A spray system comprises a button assembly, a controller, a spray hose and a spray head. Said button assembly comprises an external shell and an internal components. Said internal components comprises a FOB and a button portion. Said external shell is configured to protecting said internal components from liquids. Said external shell comprises a debris membrane, a debris membrane hold-down plate, a bottom housing and a top housing. Said internal components comprises a one or more springs. Said top housing comprises a one or more side guards, a button cavity and a one or more lower spring seats. Said FOB comprises a wireless transponder in communication with said controller. Said button portion comprises a lower extension and a one or more upper spring seats. Said one or more springs are situated between said one or more upper spring seats and said one or more lower spring seats and are configured to press said button portion and said top housing apart. Said button cavity comprises a one or more internal clips.

### BRIEF DESCRIPTION OF THE SEVERAL VIEWS OF THE DRAWING

FIG. 1 illustrates an elevated overview view of a button assembly 100.

FIG. 2 illustrates an exploded perspective view of a button assembly 100.

FIG. 3A illustrates an elevated top side view of a button assembly 100.

FIG. 3B illustrates an elevated front side view of a button assembly 100.

FIG. 3C illustrates an elevated first side view of a button assembly 100.

FIG. 3D illustrates an elevated bottom side view of a button assembly 100.

FIG. 4 illustrates an elevated front side view of a button assembly 100 at cross-section A-A.

FIG. 5A illustrates a perspective overview view of a debris membrane hold-down plate 204.

FIG. 5B illustrates an elevated top side view of a debris membrane hold-down plate 204.

FIG. 5C illustrates an elevated front side view of a debris membrane hold-down plate 204.

FIG. 6A illustrates a perspective overview view of a button portion 208.

FIG. 6B illustrates an elevated first side view of a button portion 208 at cross-section c-c.

FIG. 6C illustrates an elevated first side view of a button portion 208.

FIG. 7A illustrates an elevated front side view of a button portion 208 at cross-section B-B.

FIG. 7B illustrates an elevated front side view of a button portion 208 at detail D.

FIG. 7C illustrates an elevated front side view of a button portion 208.

FIG. 7D illustrates an elevated top side view of a button portion 208.

FIG. 8A illustrates a perspective overview view of a button portion 208.

FIG. 8B illustrates an elevated front side view of a button portion 208 with back edges exposed.

FIG. 8C illustrates an elevated top side view of a button portion 208 with back edges exposed.

FIG. 8D illustrates an elevated first side view of a button portion 208 with back edges exposed.

FIG. 8E illustrates an elevated front side view of a button portion 208 at cross-section D-D.

FIG. 9A illustrates a perspective overview view of a top housing 212.

FIG. 9B illustrates an elevated top side view of a top housing 212.

FIG. 9C illustrates an elevated front side view of a top housing 212 at cross-section E-E.

FIG. 10A illustrates a perspective overview view of a bottom housing 216.

FIG. 10B illustrates an elevated front side view of a bottom housing 216 at cross-section F-F.

FIG. 10C illustrates an elevated top side view of a bottom housing 216.

FIG. 11 illustrates a perspective overview view of a FOB 214.

FIG. 12A illustrates a perspective overview view of an exploded view 200.

FIG. 12B illustrates a perspective overview view of a one or more springs 210.

FIG. 13 illustrates a perspective overview view of a spray system 1302.

FIG. 14 illustrates a flow chart view of a method of using a safety button 1400.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below:

a button assembly 100

a button 102

a one or more side guards 104

a first side guard 104a

a second side guard 104b

an exploded view 200

a one or more screws 202

a first screw 202a

a second screw 202b

a debris membrane hold-down plate 204

a debris membrane 206

a button portion 208

a one or more springs 210

a first spring 210a

a second spring 210b

a top housing 212

a FOB 214

a bottom housing 216

an external shell 218

an internal components 220

a FOB compartment 222

a button cavity 224

an arched gap 302

a top side 304

a bottom side 306

a front side 308

a back side 310

a first side 312

a second side 314

a one or more lips 316

a first lip 316a

a second lip 316b

a one or more upper spring seats 402

a first upper spring seat 402a

a second upper spring seat 402b

a one or more lower spring seats 404

a first lower spring seat 404a

a second lower spring seat 404b

a lower extension 406

an extension aperture 408

a one or more upper screw apertures 410

a first upper screw aperture 410a

a second upper screw aperture 410b

a one or more lower screw apertures 412

a first lower screw aperture 412a

a second lower screw aperture 412b

an outer wall 414

an outer wall 416

a button aperture 502

a one or more screw apertures 504

a first screw aperture 504a

a second screw aperture 504b

a plate 506

a top surface 508

a bottom surface 510

a side surface 512

a button portion 602

a one or more screw apertures 604

a first screw aperture 604a

a second screw aperture 604b

a body 606

a top surface 608

a bottom surface 610

a one or more sides 612

a first side 612a

a second side 612b

a one or more side clips 802

a first side clip 802a

a second side clip 802b

a side portions 804

a top portion 806

a front side 808

a back side 810

a first side 812a

a second side 812b

a top side 814

a bottom side 816

a one or more internal clips 902

a first internal clip 902a

a second internal clip 902b

a top side 904

a bottom side 906

a front side 908

a back side 910

a first side 912

a second side 914

a lip 1002

a shelf 1004

a one or more strap holes 1006

a first strap hole 1006a

a second strap hole 1006b

a one or more vent holes 1008

a first vent hole 1008a

a second vent hole 1008b

a one or more vent holes 1010

a first vent hole 1010a

a second vent hole 1010b

a button 1102

a shell 1104

a spray system 1302

a reservoir 1304

a spray hose 1306

a spray head 1308

a broadcast distance 1310

a controller 1312

a signal 1314

a method of using a safety button 1400

a connecting a button assembly and controller step 1402

a selectively engaging said controller and a spray system with said button assembly step 1404

a disengaging said spray system when a signal between said button assembly and said controller is lost step 1406

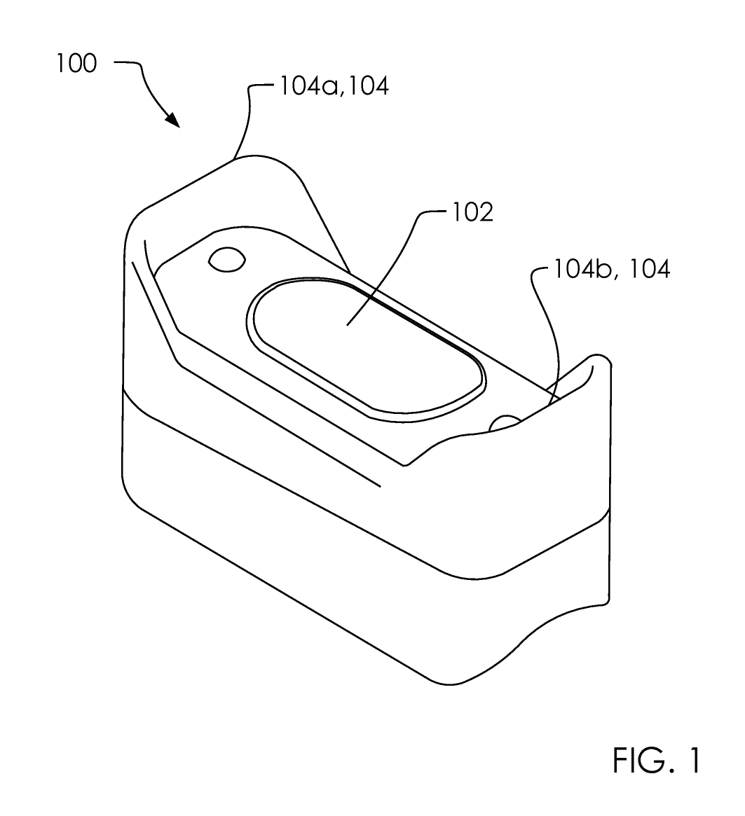

FIG. 1 illustrates an elevated overview view of a button assembly 100.

In one embodiment, said button assembly 100 can comprise said button 102.

In one embodiment, said one or more side guards 104 can comprise said first side guard 104a and said second side guard 104b.

In one embodiment, said button assembly 100 can comprise said button 102 protected between said one or more side guards 104, as illustrated. Therefore, said button 102 can be protected from accidental drops and unintentional triggering events.

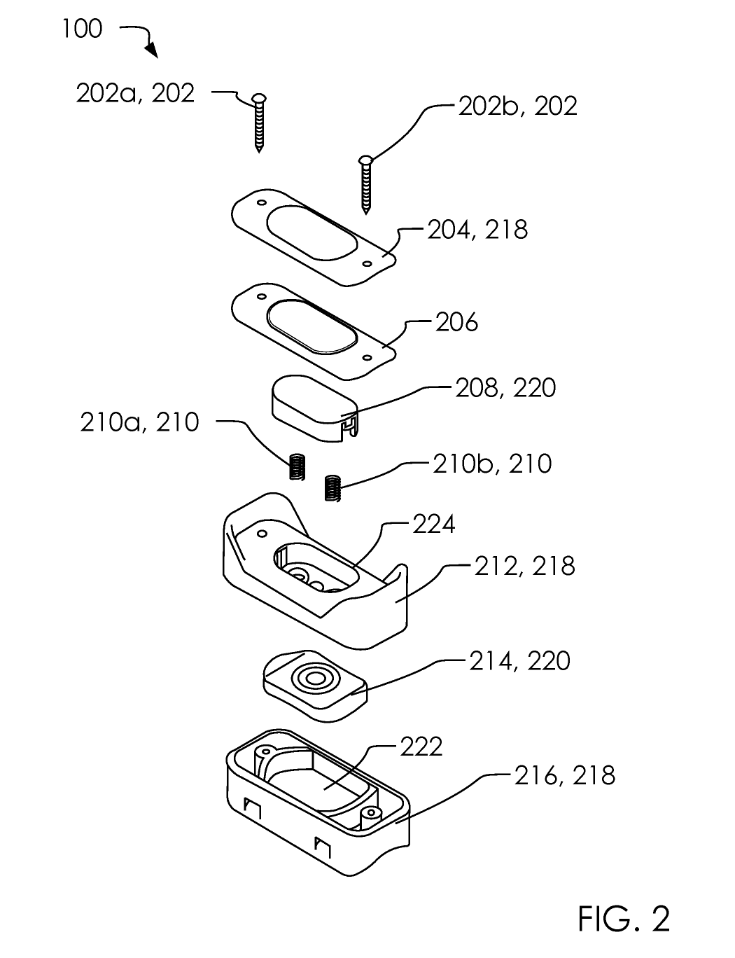

FIG. 2 illustrates an exploded perspective view of a button assembly 100.

In one embodiment, said one or more screws 202 can comprise said first screw 202a and said second screw 202b.

In one embodiment, said one or more springs 210 can comprise said first spring 210a and said second spring 210b.

In one embodiment, said top housing 212 can comprise said button cavity 224.

In one embodiment, said bottom housing 216 can comprise said FOB compartment 222.

In one embodiment, said external shell 218 can comprise said debris membrane hold-down plate 204, said top housing 212 and said bottom housing 216.

In one embodiment, said internal components 220 can comprise said button portion 208, said one or more springs 210 and said FOB 214.

In one embodiment, said button assembly 100 can comprise said exploded view 200, said one or more screws 202, said debris membrane hold-down plate 204, said debris membrane 206, said button portion 208, said one or more springs 210, said top housing 212, said FOB 214, said bottom housing 216, said external shell 218 and said internal components 220.

Said button assembly 100 can comprise many subcomponents, as illustrated. Said external shell 218 can protect said internal components 220 from environmental damage by being assembled in a sealed fashion. Said FOB 214 can be arranged between said top housing 212 and said bottom housing 216 in said FOB compartment 222.

In one embodiment, said button assembly 100 can be assembled by: placing said FOB 214 into said FOB compartment 222 of said bottom housing 216; attaching said top housing 212 to a top portion of said bottom housing 216; said one or more springs 210 and said button portion 208 slide into said button cavity 224; pressing said debris membrane 206 over a portion of said top housing 212 and said button portion 208; pressing and holding said debris membrane 206 down with said debris membrane hold-down plate 204; and holding all other components together with said one or more screws 202.

Said one or more springs 210 can cause said button portion 208 to recoil up after being pressed down. Accordingly, said FOB 214 can be pressed and depressed by pushing said button portion 208 down.

In one embodiment, said FOB 214 can be engaged with a portion of said button portion 208, as discussed below.

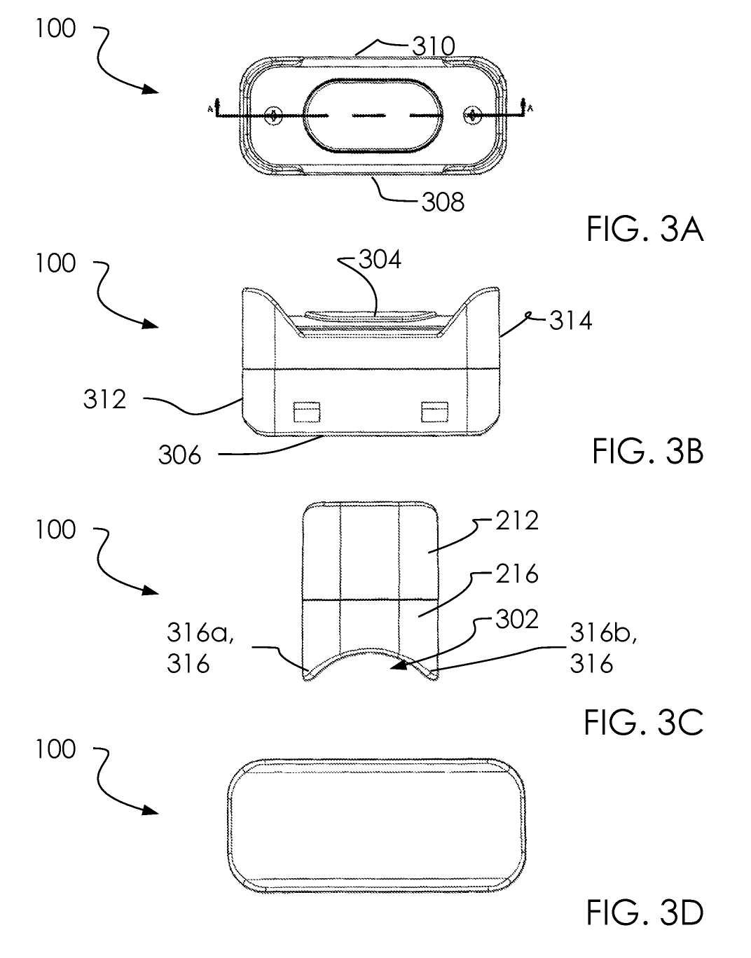

FIG. 3A illustrates an elevated top side view of a button assembly 100.

FIG. 3B illustrates an elevated front side view of a button assembly 100.

FIG. 3C illustrates an elevated first side view of a button assembly 100.

FIG. 3D illustrates an elevated bottom side view of a button assembly 100.

In one embodiment, said one or more lips 316 can comprise said first lip 316a and said second lip 316b.

In one embodiment, said button assembly 100 can comprise said top side 304, said bottom side 306, said front side 308, said back side 310, said first side 312 and said second side 314.

In one embodiment, said bottom housing 216 can comprise said arched gap 302 and said one or more lips 316.

In one embodiment, said top housing 212 and said bottom housing 216 fit together to form a portion of said external shell 218.

In one embodiment, a portion of said bottom housing 216 at said bottom side 306 can comprise said arched gap 302. Said arched gap 302 can comprise a cylindrical cut out extending from said first side 312 to said second side 314. In one embodiment, said arched gap 302 can be designed to ensure a quick and easy grip by a user holding said button assembly 100. In one embodiment, said one or more lips 316 can be on either side of said arched gap 302, with said first lip 316a at said/front side 308 and said second lip 316b at said back side 310.

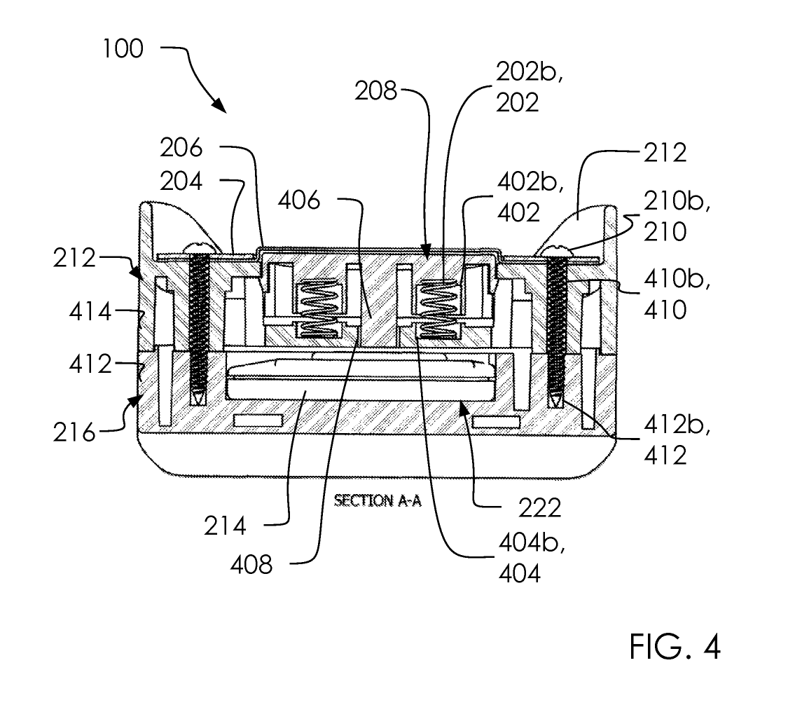

FIG. 4 illustrates an elevated front side view of a button assembly 100 at cross-section A-A.

In one embodiment, said one or more upper spring seats 402 can comprise said first upper spring seat 402a and said second upper spring seat 402b.

In one embodiment, said one or more lower spring seats 404 can comprise said first lower spring seat 404a and said second lower spring seat 404b.

In one embodiment, said one or more upper screw apertures 410 can comprise said first upper screw aperture 410a and said second upper screw aperture 410b.

In one embodiment, said one or more lower screw apertures 412 can comprise said first lower screw aperture 412a and said second lower screw aperture 412b.

In one embodiment, said button portion 208 can comprise said one or more upper spring seats 402 and said lower extension 406.

In one embodiment, said top housing 212 can comprise said one or more lower spring seats 404, said extension aperture 408, said one or more upper screw apertures 410 and said outer wall 414.

In one embodiment, said bottom housing 216 can comprise said one or more lower screw apertures 412 and said outer wall 416.

In one embodiment, said one or more screws 202 can be situated between said one or more upper spring seats 402 and said one or more lower spring seats 404 and press said button portion 208 upward between said debris membrane 206 and a portion of said top housing 212. Said one or more upper spring seats 402 can each comprise a socket on a lower side of said button portion 208. Likewise, each among said one or more lower spring seats 404 can comprise an upward facing socket in a portion of said top housing 212. Said one or more upper spring seats 402 and said one or more lower spring seats 404 can be aligned with one another so that said one or more screws 202 can be pressed therebetween.

In one embodiment, said extension aperture 408 can comprise a hole in a portion of said top housing 212 which can allow a portion of said lower extension 406 to pass freely through to selectively press into said FOB 214.

In one embodiment, said FOB 214 is configured to snuggly fit in said FOB compartment 222 of said bottom housing 216.

In one embodiment, said outer wall 414 of said top housing 212 can selectively fit within a portion of said one or more lower screw apertures 412 of said bottom housing 216.

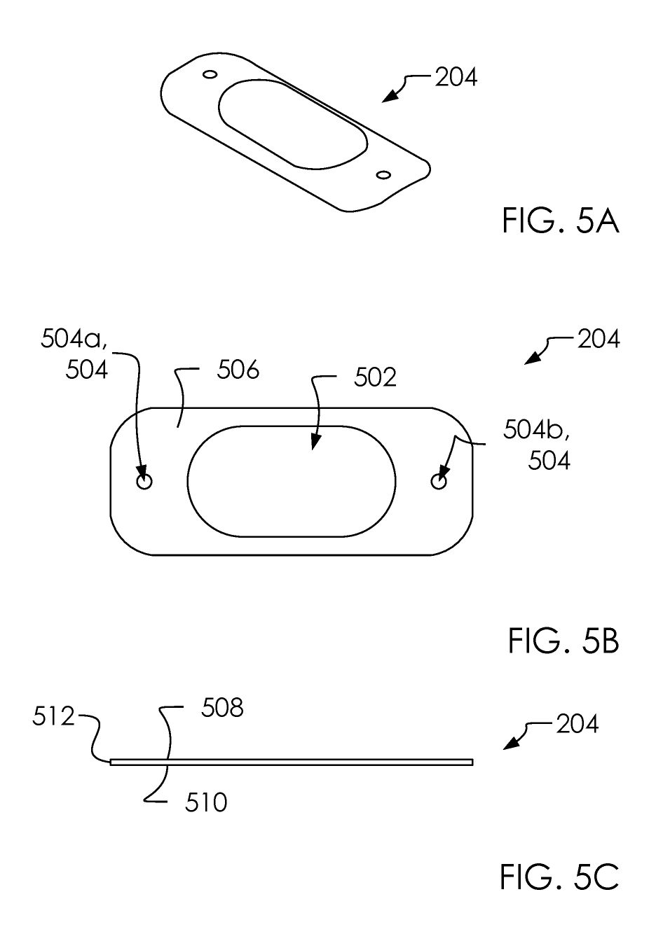

FIG. 5A illustrates a perspective overview view of a debris membrane hold-down plate 204.

FIG. 5B illustrates an elevated top side view of a debris membrane hold-down plate 204.

FIG. 5C illustrates an elevated front side view of a debris membrane hold-down plate 204.

In one embodiment, said one or more screw apertures 504 can comprise said first screw aperture 504a and said second screw aperture 504b.

In one embodiment, said debris membrane hold-down plate 204 can comprise said button aperture 502, said one or more screw apertures 504, said plate 506, said top surface 508, said bottom surface 510 and said side surface 512.

In one embodiment, said debris membrane hold-down plate 204 can comprise a curved shape (as shown in FIG. 5A) or a flat shape (as in FIG. 5C). In one embodiment, said button aperture 502 can allow a portion of said button portion 208 to pass freely through.

In one embodiment, said one or more screw apertures 504 can allow a portion of said one or more springs 210 to pass through.

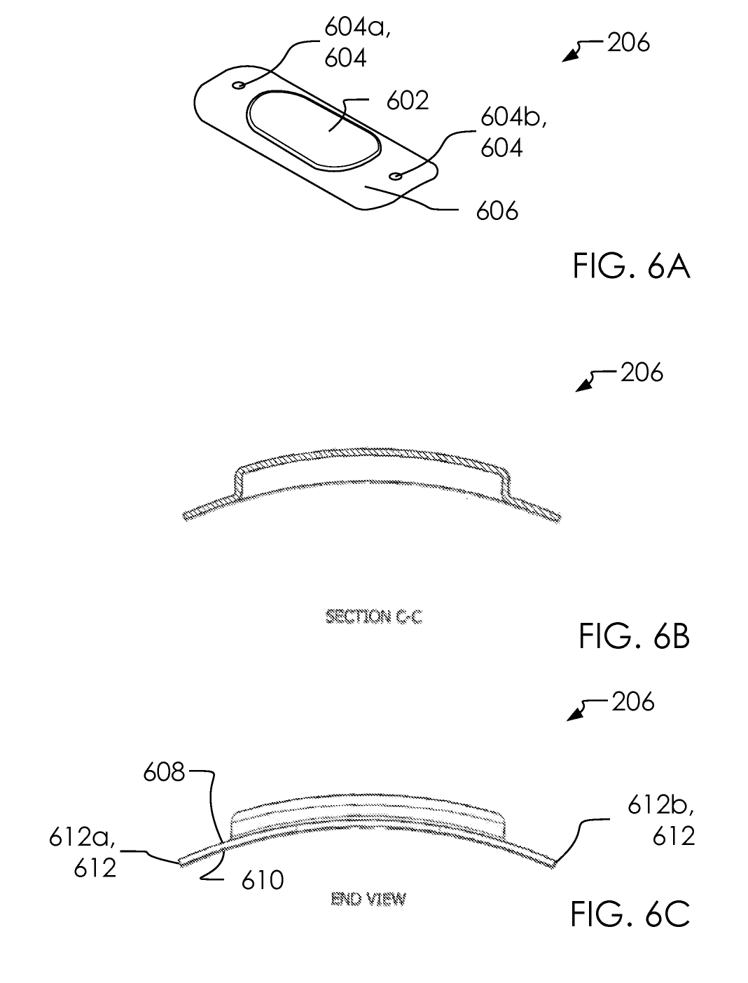

FIG. 6A illustrates a perspective overview view of a button portion 208.

FIG. 6B illustrates an elevated first side view of a button portion 208 at cross-section c-c.

FIG. 6C illustrates an elevated first side view of a button portion 208.

In one embodiment, said one or more screw apertures 604 can comprise said first screw aperture 604a and said second screw aperture 604b.

In one embodiment, said one or more sides 612 can comprise said first side 612a and said second side 612b.

In one embodiment, said debris membrane 206 can comprise said button portion 602, said one or more screw apertures 604, said body 606, said top surface 608, said bottom surface 610 and said one or more sides 612.

In one embodiment, said body 606 can comprise a rubber, silicon or other pliable material being able to allow movement of said button portion 208 and maintain a weather seal around said internal components 220.

In one embodiment, said button portion 602 can comprise an embossed portion of said body 606 to accommodate movement of said button portion 208.

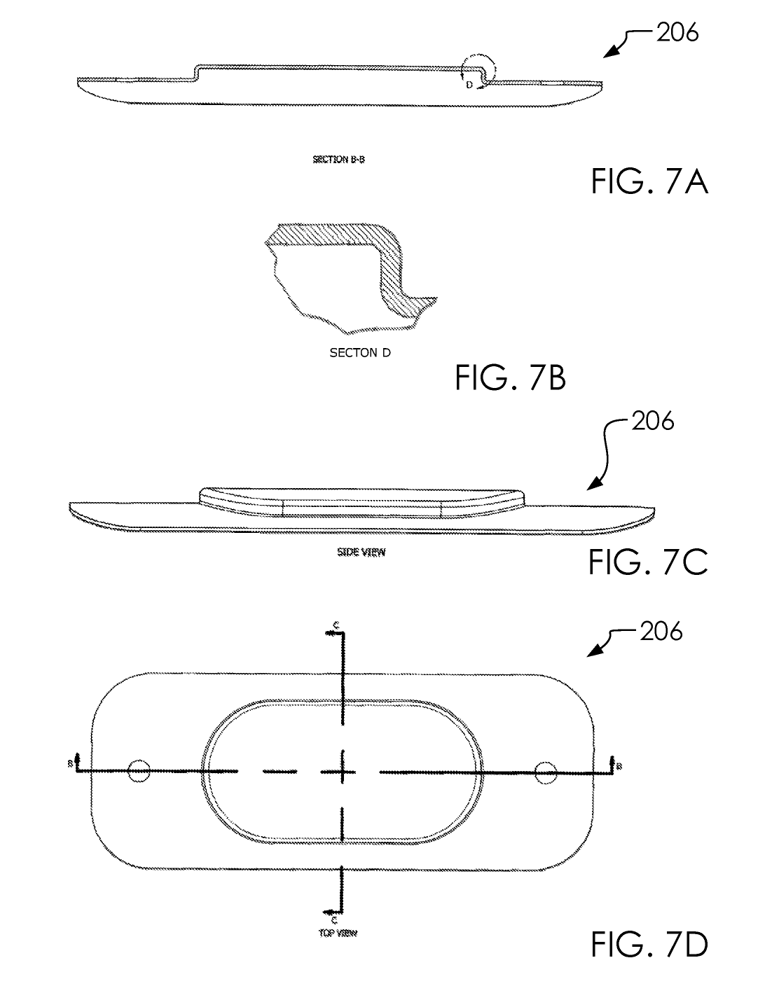

FIG. 7A illustrates an elevated front side view of a button portion 208 at cross-section B-B.

FIG. 7B illustrates an elevated front side view of a button portion 208 at detail D.

FIG. 7C illustrates an elevated front side view of a button portion 208.

FIG. 7D illustrates an elevated top side view of a button portion 208.

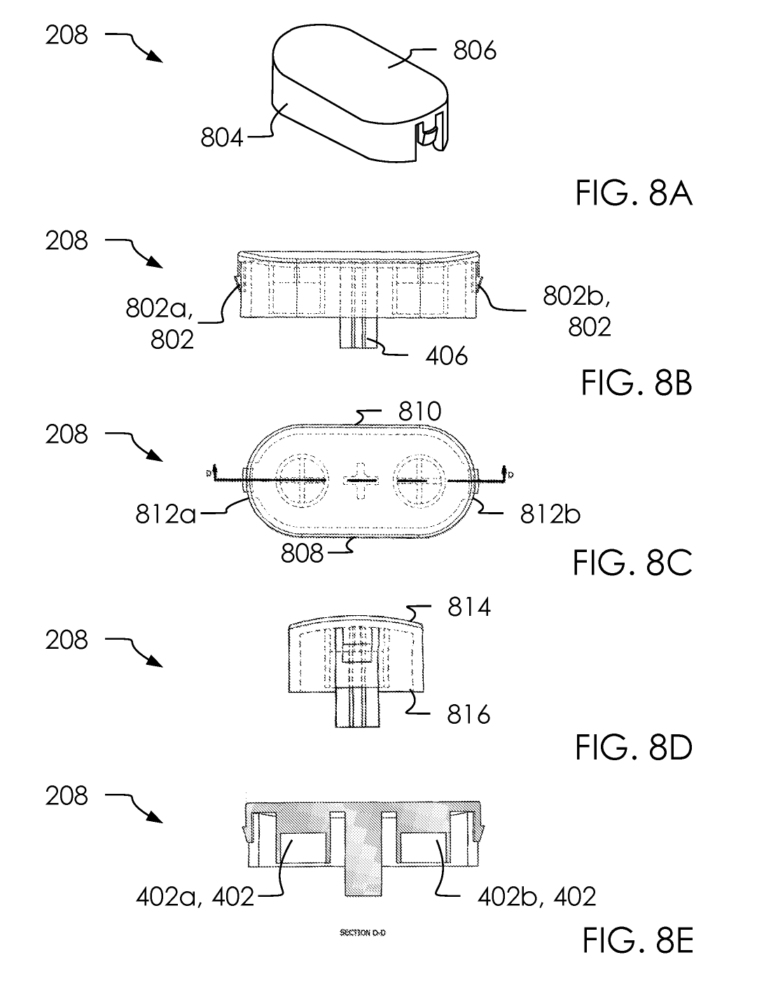

FIG. 8A illustrates a perspective overview view of a button portion 208.

FIG. 8B illustrates an elevated front side view of a button portion 208 with back edges exposed.

FIG. 8C illustrates an elevated top side view of a button portion 208 with back edges exposed.

FIG. 8D illustrates an elevated first side view of a button portion 208 with back edges exposed.

FIG. 8E illustrates an elevated front side view of a button portion 208 at cross-section D-D.

In one embodiment, said one or more side clips 802 can comprise said first side clip 802a and said second side clip 802b.

In one embodiment, said button portion 208 can comprise said side portions 804, said top portion 806, said front side 808, said back side 810, said back side 810, said top side 814 and said bottom side 816.

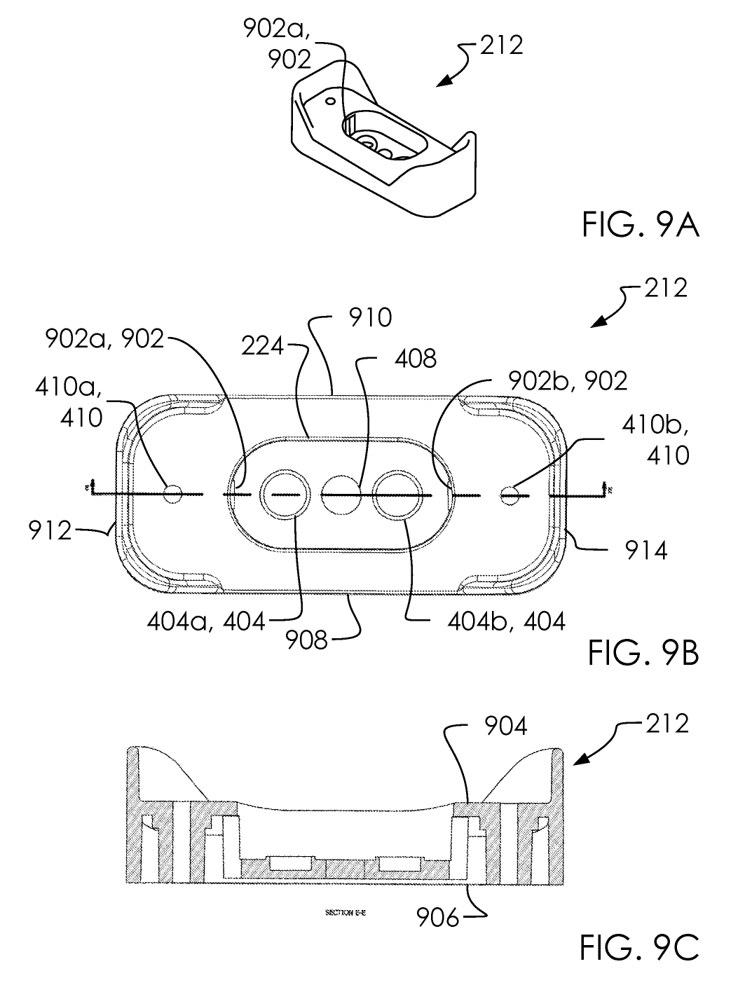

FIG. 9A illustrates a perspective overview view of a top housing 212.

FIG. 9B illustrates an elevated top side view of a top housing 212.

FIG. 9C illustrates an elevated front side view of a top housing 212 at cross-section E-E.

In one embodiment, said one or more internal clips 902 can comprise said first internal clip 902a and said second internal clip 902b.

In one embodiment, said top housing 212 can comprise said one or more internal clips 902, said top side 904, said bottom side 906, said front side 908, said back side 910, said first side 912 and said second side 914.

In one embodiment, said one or more internal clips 902 can selectively receive a portion of said one or more side clips 802 in order to ensure said button portion 208 does not accidentally pop out of said button cavity 224.

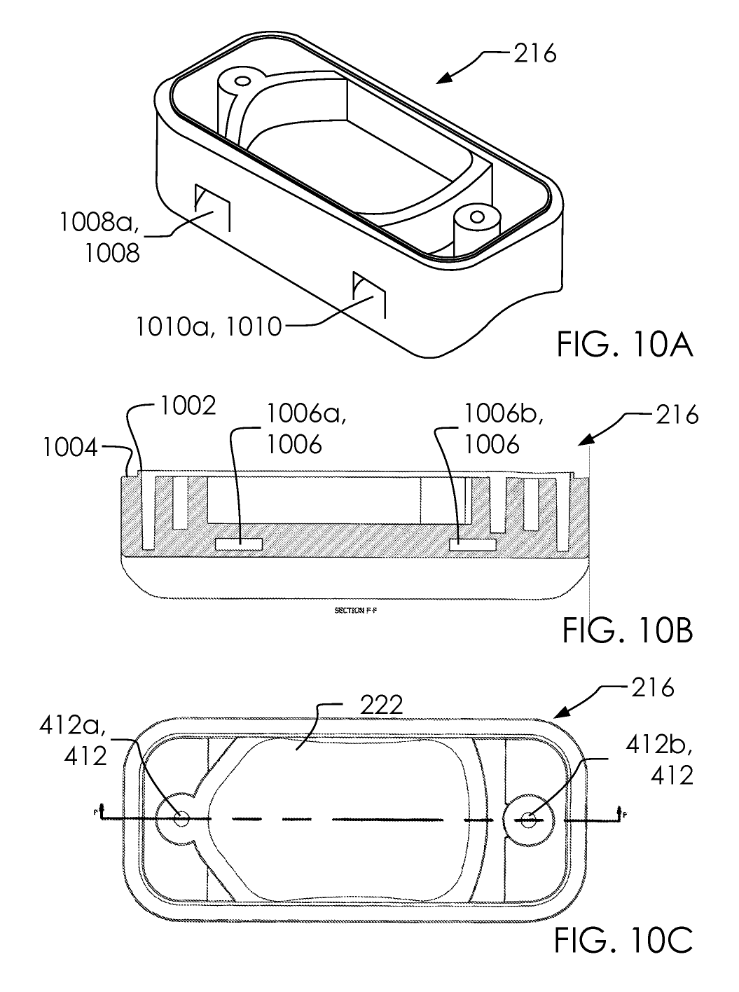

FIG. 10A illustrates a perspective overview view of a bottom housing 216.

FIG. 10B illustrates an elevated front side view of a bottom housing 216 at cross-section F-F.

FIG. 10C illustrates an elevated top side view of a bottom housing 216.

In one embodiment, said one or more strap holes 1006 can comprise said first strap hole 1006a and said second strap hole 1006b.

In one embodiment, said one or more vent holes 1008 can comprise said first vent hole 1008a and said second vent hole 1008b.

In one embodiment, said one or more vent holes 1010 can comprise said first vent hole 1010a and said second vent hole 1010b.

In one embodiment, said bottom housing 216 can comprise said lip 1002, said shelf 1004, said one or more strap holes 1006, said one or more vent holes 1008 and said one or more vent holes 1010.

In one embodiment, said lip 1002 and said shelf 1004 can comprise a portion of said one or more lower screw apertures 412, and can receive a portion of said outer wall 414.

In one embodiment, said FOB compartment 222 can comprise a portion of said bottom housing 216 formed to hold said FOB 214 without lateral movement thereof.

In one embodiment, said one or more vent holes 1008 and said one or more vent holes 1010 can be on either side of said bottom housing 216, with said one or more strap holes 1006 being accessible therethrough. For example, said first vent hole 1008a connects to said 1006a, which connects to said second vent hole 1008b (not illustrated here). Accordingly, said one or more strap holes 1006 can be a hole through a lower portion of said bottom housing 216. In one embodiment, said one or more strap holes 1006 can receive a strap or a clip, configured to releaseably hold said button assembly 100.

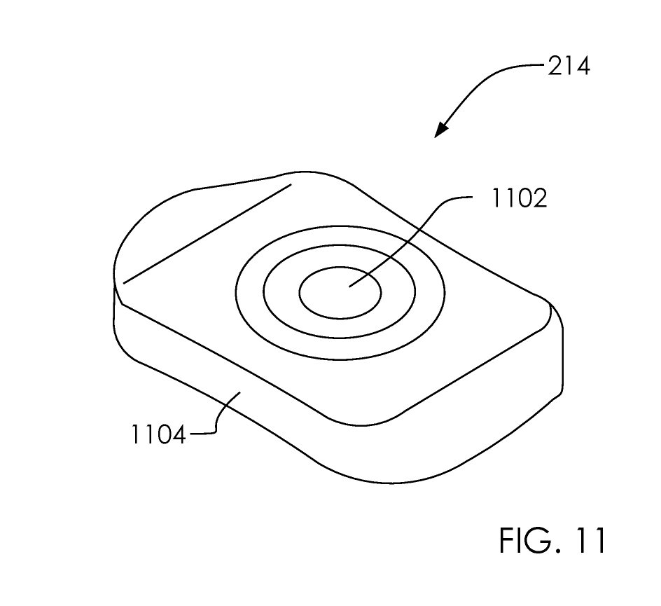

FIG. 11 illustrates a perspective overview view of a FOB 214.

In one embodiment, said FOB 214 can comprise said button 1102 and said shell 1104.

In one embodiment, said FOB 214 can comprise an RF remote or other wireless remote, as known in the art. Alternatively, said button assembly 100 can comprise the remote features sealed in a large hand sized button, and skip the modular installation of a separate FOB at this step.

In one embodiment, said shell 1104 holds an internal IC, transmitter, and battery, as is known in the art.

In one embodiment, said lower extension 406 can be configured to press said button 1102.

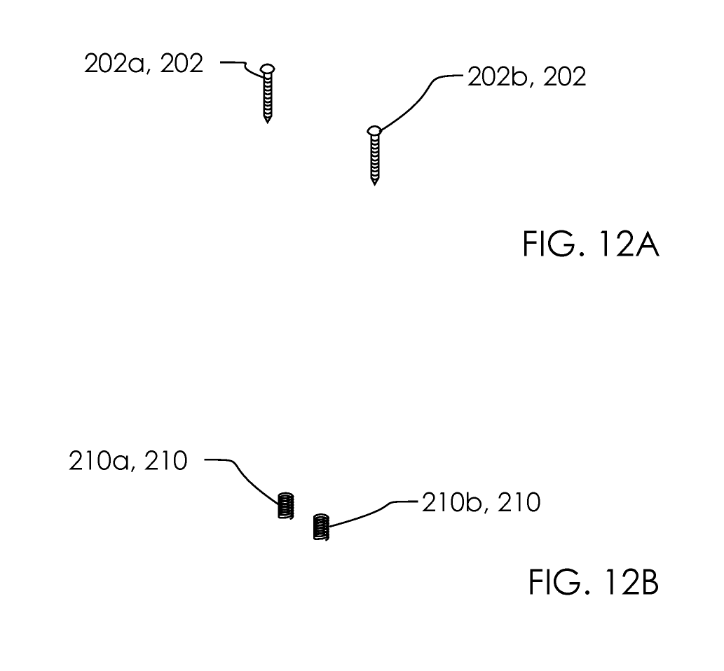

FIG. 12A illustrates a perspective overview view of an exploded view 200.

FIG. 12B illustrates a perspective overview view of a one or more springs 210.

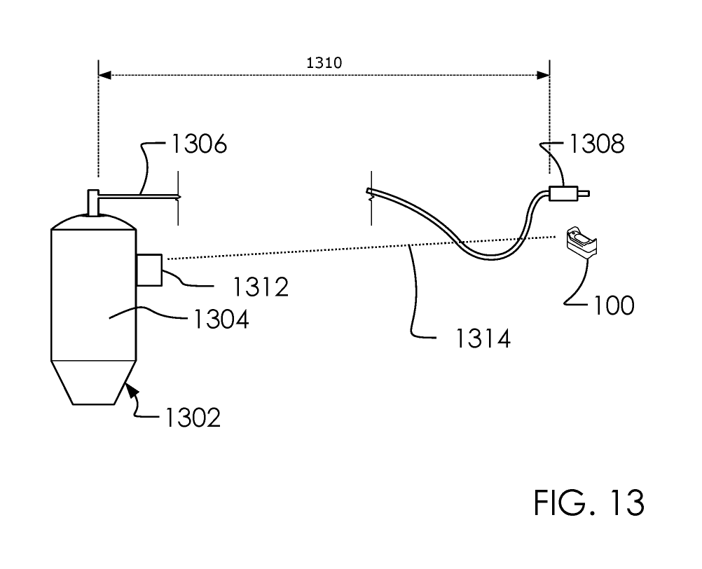

FIG. 13 illustrates a perspective overview view of a spray system 1302.

In one embodiment, said spray system 1302 can comprise said reservoir 1304, said spray hose 1306, said spray head 1308 and said controller 1312.

In one embodiment, said button assembly 100 can comprise a portion of said spray system 1302 for engaging and disengaging a spraying cycle. Accordingly, said pressing said button portion 208 of said button assembly 100 can cause said spray system 1302 to engage and send a stream of spray particles to said spray head 1308, as desired by an end user.

In one embodiment, said button assembly 100 can step into said spray head 1308 with said one or more vent holes 1008 and/or said one or more vent holes 1010.

In one embodiment, said button assembly 100 can be configured to fail-safe such that losing said signal 1314 or accidentally dropping said spray head 1308 and/or said button assembly 100 will disengage said spray system 1302.

In one embodiment, said button assembly 100 can communicate with said controller 1312 which can in turn engage said spray system 1302 as desired by an end user.

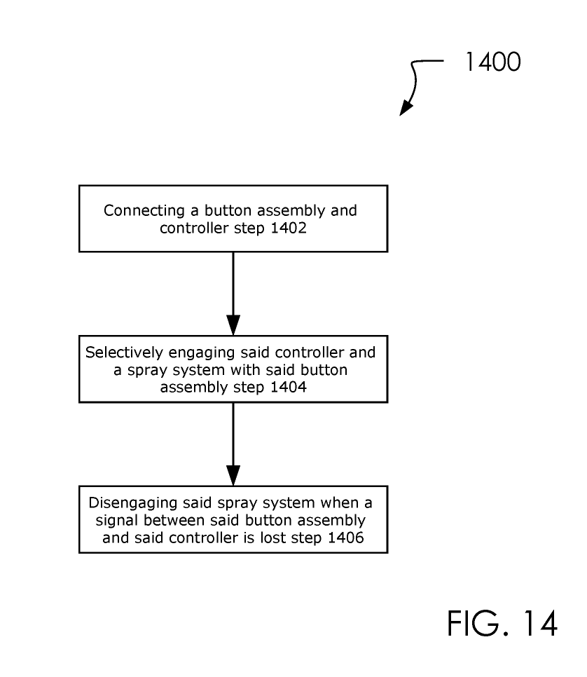

FIG. 14 illustrates a flow chart view of a method of using a safety button 1400.

In one embodiment, said method of using a safety button 1400 can comprise said connecting a button assembly and controller step 1402, said selectively engaging said controller and a spray system with said button assembly step 1404 and said disengaging said spray system when a signal between said button assembly and said controller is lost step 1406.

The following sentences are included for completeness of this disclosure with reference to the claims.

A spray system 1302. Said spray system 1302 comprises a button assembly 100, a controller 1312, a spray hose 1306 and a spray head 1308. Said button assembly 100 comprises an external shell 218 and an internal components 220. Said internal components 220 comprises a FOB 214 and a button portion 208. Said external shell 218 is configured to protecting said internal components from liquids. Said external shell 218 comprises a debris membrane 206, a debris membrane hold-down plate 204, a bottom housing 216 and a top housing 212. Said internal components 220 comprises a one or more springs 210. Said top housing 212 comprises a one or more side guards 104, a button cavity 224 and a one or more lower spring seats 404. Said FOB 214 comprises a wireless transponder in communication with said controller. Said button portion 208 comprises a lower extension 406 and a one or more upper spring seats 402. Said one or more springs 210 are situated between said one or more upper spring seats and said one or more lower spring seats and are configured to press said button portion and said top housing apart. Said button cavity 224 comprises a one or more internal clips 902. A spray system 1302.

Said spray system 1302 comprises a button assembly 100, a controller 1312, a spray hose 1306, a spray head 1308, a top side 304, a bottom side 306, a front side 308, a back side 310, a first side 312 and a second side 314. Said button assembly 100 comprises an external shell 218, an internal components 220 and a button 102. Said internal components 220 comprises a FOB 214 and a button portion 208. Said external shell 218 is configured to protecting said internal components from liquids. Said FOB 214 comprises a wireless transponder in communication with said controller.

Said external shell 218 comprises a top housing 212 and a bottom housing 216.

Said button portion 208 comprises an arched gap 302 and a one or more lips 316. Said arched gap 302 comprise an arched portion of said bottom housing between said one or more lips.

Said top housing 212 comprises a one or more side guards 104. Said one or more side guards 104 extend up and above said button so as to protect said button from being accidentally pressed.

Said button assembly 100 is configured to be fail-safe with respect to said controller of said spray system.

Said button assembly 100 comprises a signal 1314 with said controller. Said signal 1314 comprises a wireless signal between said controller and said button assembly. Said controller 1312 is configured to disengage said spray system upon losing said signal.

A top housing 212 comprises a one or more side guards 104 and a button cavity 224.

Said external shell 218 comprises a debris membrane 206, a debris membrane hold-down plate 204, a bottom housing 216 and a top housing 212.

Said internal components 220 comprises a one or more springs 210.

A debris membrane 206 comprises a water proof material being designed to protect said internal components of said button assembly.

Said debris membrane 206 is pressed against a portion of said top housing with a portion of said debris membrane hold-down plate.

Said FOB 214 comprises a button 1102 and a shell 1104. Said button portion 208 comprises a lower extension 406. Said lower extension 406 is configured to selectively press into said button of said FOB.

A debris membrane 206 are configured to allow movement of said button portion and maintain a weather seal around said internal components.

A bottom housing 216 comprises a one or more lower spring seats 404. A top housing 212 comprises a one or more upper spring seats 402. A one or more springs 210 are situated between said one or more upper spring seats and said one or more lower spring seats and are configured to press said button portion and said top housing apart.

Said button assembly 100 comprises a one or more screws 202. A top housing 212 comprises a top side 904, a bottom side 906, a front side 908, a back side 910, a first side 912 and a second side 914. A debris membrane hold-down plate 204 comprises a one or more screw apertures 504, a button aperture 502, a top surface 508, a bottom surface 510 and a side surface 512. A debris membrane 206 comprises a button portion 602, a one or more screw apertures 604, a body 606, a top surface 608, a bottom surface 610 and a one or more sides 612. A bottom housing 216 comprises a one or more internal clips 902 and a one or more lower screw apertures 412. Said one or more screws 202 are configured to hold portions of said button assembly together by: scre3wing through said one or more screw apertures of said debris membrane hold-down plate, said one or more screw apertures of said debris membrane, said one or more upper screw apertures of said top housing, and a portion of said one or more lower screw apertures of said bottom housing.

Said button assembly 100 comprises a one or more screws 202. A top housing 212 comprises a top side 904, a bottom side 906, a front side 908, a back side 910, a first side 912 and a second side 914. A debris membrane hold-down plate 204 comprises a one or more screw apertures 504, a button aperture 502, a top surface 508, a bottom surface 510 and a side surface 512. A debris membrane 206 comprises a button portion 602, a one or more screw apertures 604, a body 606, a top surface 608, a bottom surface 610 and a one or more sides 612. A bottom housing 216 comprises a one or more internal clips 902 and a one or more lower screw apertures 412. Said one or more screws 202 are configured to hold portions of said button assembly together by: scre3wing through said one or more screw apertures of said debris membrane hold-down plate, said one or more screw apertures of said debris membrane, said one or more upper screw apertures of said top housing, and a portion of said one or more lower screw apertures of said bottom housing.

Said debris membrane 206 comprises a material selected from among a rubber or a silicon.

Said button aperture 502 is configured to allow a portion of said debris membrane to pass through and thereby allow said button portion to be pressed into a portion of said FOB.

A button cavity 224 comprises a one or more internal clips 902. Said button cavity 224 and said button portion comprise a similar shape so as to nest said button cavity in said button portion and allow movement in a z-axis. Said button portion 208 comprises a one or more side clips 802. Said one or more side clips 802 are configured to catch on a portion of said one or more internal clips with a portion of said button portion situated inside of said button cavity. A method of using a safety button 1400.

Said method of using a safety button 1400 comprises a connecting a button assembly and controller step 1402, a selectively engaging said controller and a spray system with said button assembly step 1404 and a disengaging said spray system when a signal between said button assembly and said controller is lost step 1406. Comprises: creating a wireless signal between a button assembly and a controller of. A spray system 1302 comprises a button assembly 100, a controller 1312, a spray hose 1306 and a spray head 1308. Said button assembly 100 comprises an external shell 218 and an internal components 220. Said internal components 220 comprises a FOB 214 and a button portion 208. Said external shell 218 is configured to protecting said internal components from liquids. Said external shell 218 comprises a debris membrane 206, a debris membrane hold-down plate 204, a bottom housing 216 and a top housing 212. Said internal components 220 comprises a one or more springs 210. Said top housing 212 comprises a one or more side guards 104, a button cavity 224 and a one or more lower spring seats 404. Said FOB 214 comprises a wireless transponder in communication with said controller. Said button portion 208 comprises a lower extension 406 and a one or more upper spring seats 402. Said one or more springs 210 are situated between said one or more upper spring seats and said one or more lower spring seats and are configured to press said button portion and said top housing apart. Said button cavity 224 comprises a one or more internal clips 902.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A spray system, wherein:
said spray system comprises a button assembly, a controller, a spray hose and a spray head;
said button assembly comprises an external shell and an internal components;
said internal components comprises a FOB and a button portion;
said external shell is configured to protecting said internal components from liquids;
said external shell comprises a debris membrane, a debris membrane hold-down plate, a bottom housing and a top housing;
said internal components comprises a one or more springs;
said top housing comprises a one or more side guards, a button cavity and a one or more lower spring seats;
said FOB comprises a wireless transponder in communication with said controller;
said button portion comprises a lower extension and a one or more upper spring seats;
said one or more springs are situated between said one or more upper spring seats and
said one or more lower spring seats and are configured to press said button portion and said top housing apart; and
said button cavity comprises a one or more internal clips.

2. A spray system, wherein:
said spray system comprises a button assembly, a controller, a spray hose, a spray head, a top side, a bottom side, a front side, a back side, a first side and a second side;
said button assembly comprises an external shell, an internal components and a button;
said internal components comprises a FOB and a button portion;
said external shell is configured to protecting said internal components from liquids; and
said FOB comprises a wireless transponder in communication with said controller.

3. The spray system from claim 2, wherein:
said external shell comprises a top housing and a bottom housing.

4. The spray system from claim 3, wherein:
said button portion comprises an arched gap and a one or more lips; and
said arched gap comprise an arched portion of said bottom housing between said one or more lips.

5. The spray system from claim 3, wherein:
said top housing comprises a one or more side guards; and
said one or more side guards extend up and above said button so as to protect said button from being accidentally pressed.

6. The spray system from claim 2, wherein:
said button assembly is configured to be fail-safe with respect to said controller of said spray system.

7. The spray system from claim 6, wherein:
said button assembly comprises a signal with said controller;
said signal comprises a wireless signal between said controller and said button assembly; and
said controller is configured to disengage said spray system upon losing said signal.

8. The spray system from claim 2, wherein:
a top housing comprises a one or more side guards and a button cavity.

9. The spray system from claim 2, wherein:
said external shell comprises a debris membrane, a debris membrane hold-down plate, a bottom housing and a top housing.

10. The spray system from claim 2, wherein:
said internal components comprises a one or more springs.

11. The spray system from claim 2, wherein:
a debris membrane comprises a water proof material being designed to protect said internal components of said button assembly.

12. The spray system from claim 11, wherein:
said debris membrane is pressed against a portion of said top housing with a portion of said debris membrane hold-down plate.

13. The spray system from claim 2, wherein:
said FOB comprises a button and a shell;
said button portion comprises a lower extension; and
said lower extension is configured to selectively press into said button of said FOB.

14. The spray system from claim 13, wherein:
a debris membrane is configured to allow movement of said button portion and maintain a weather seal around said internal components.

15. The spray system from claim 2, wherein:
a bottom housing comprises a one or more lower spring seats;
a top housing comprises a one or more upper spring seats; and
a one or more springs are situated between said one or more upper spring seats and said one or more lower spring seats and are configured to press said button portion and said top housing apart.

16. The spray system from claim 2, wherein:
said button assembly comprises a one or more screws;
a top housing comprises a top side, a bottom side, a front side, a back side, a first side and a second side;
a debris membrane hold-down plate comprises a one or more screw apertures, a button aperture, a top surface, a bottom surface and a side surface;
a debris membrane comprises a button portion, a one or more screw apertures, a body, a top surface, a bottom surface and a one or more sides;
a bottom housing comprises a one or more internal clips and a one or more lower screw apertures; and
said one or more screws are configured to hold portions of said button assembly together by: scre3wing through said one or more screw apertures of said debris membrane hold-down plate, said one or more screw apertures of said debris membrane, said one or more upper screw apertures of said top housing, and a portion of said one or more lower screw apertures of said bottom housing.

17. The spray system from claim 2, wherein:
said button assembly comprises a one or more screws;
a top housing comprises a top side, a bottom side, a front side, a back side, a first side and a second side;
a debris membrane hold-down plate comprises a one or more screw apertures, a button aperture, a top surface, a bottom surface and a side surface;
a debris membrane comprises a button portion, a one or more screw apertures, a body, a top surface, a bottom surface and a one or more sides;
a bottom housing comprises a one or more internal clips and a one or more lower screw apertures; and
said one or more screws are configured to hold portions of said button assembly together by: scre3wing through said one or more screw apertures of said debris membrane hold-down plate, said one or more screw apertures of said debris membrane, said one or more upper screw apertures of said top housing, and a portion of said one or more lower screw apertures of said bottom housing.

18. The spray system from claim 17, wherein:
said debris membrane comprises a material selected from among a rubber or a silicon; and
said button aperture is configured to allow a portion of said debris membrane to pass through and thereby allow said button portion to be pressed into a portion of said FOB.

19. The spray system from claim 2, wherein:
a button cavity comprises a one or more internal clips;
said button cavity and said button portion comprise a similar shape so as to nest said button cavity in said button portion and allow movement in a z-axis;
said button portion comprises a one or more side clips; and
said one or more side clips are configured to catch on a portion of said one or more internal clips with a portion of said button portion situated inside of said button cavity.

20. A method of using a safety button, wherein:
said method of using a safety button comprises a connecting a button assembly and controller step, a selectively engaging said controller and a spray system with said button assembly step and a disengaging said spray system when a signal between said button assembly and said controller is lost step;
comprises: creating a wireless signal between a button assembly and a controller of;
a spray system comprises a button assembly, a controller, a spray hose and a spray head;
said button assembly comprises an external shell and an internal components;
said internal components comprises a FOB and a button portion;
said external shell is configured to protecting said internal components from liquids;
said external shell comprises a debris membrane, a debris membrane hold-down plate, a bottom housing and a top housing;
said internal components comprises a one or more springs;
said top housing comprises a one or more side guards, a button cavity and a one or more lower spring seats;
said FOB comprises a wireless transponder in communication with said controller;
said button portion comprises a lower extension and a one or more upper spring seats;
said one or more springs are situated between said one or more upper spring seats and
said one or more lower spring seats and are configured to press said button portion and said top housing apart; and
said button cavity comprises a one or more internal clips.
